(19) United States
(12) Patent Application Publication
(10) Pub. No.: US 2024/0324688 A1
(43) Pub. Date: Oct. 3, 2024

(54) Portable Device with Casing Access Depending on the Detection of a User's Hand

(71) Applicant: JT International SA, Geneva (CH)

(72) Inventor: Akira Yamaguchi, Geneva (CH)

(73) Assignee: JT International SA, Geneva (CH)

(21) Appl. No.: 18/293,934

(22) PCT Filed: Aug. 16, 2022
(86) PCT No.: PCT/EP2022/072818

§ 371 Date: Jan. 31, 2024

(30) Foreign Application Priority Data
Aug. 26, 2021 (EP) 21193210.8

(51) Int. Cl. A24F 40/51; A24F 40/20; A24F 40/40; A24F 40/53

(52) U.S. Cl. CPC A24F 40/51; A24F 40/20; A24F 40/40; A24F 40/53

(57) ABSTRACT

A portable device includes a body including a casing with an opening and a closure element moveable between a closed position occluding this casing opening and an open position authorizing access to the casing. The body further includes a first sensor set in a chosen area and arranged for detecting a user's hand holding the body in this chosen area, and a mechanism arranged for causing the closure element to move to its open position when the user's hand has been detected by the first sensor.

### FIELD OF THE INVENTION

The present invention relates to portable devices having a body comprising a closure element controlling access to a casing, and more precisely to the automatic control of the movement of this closure element when users start using such portable devices.

### BACKGROUND

Some portable devices comprise a body comprising a casing with an opening and a closure element moveable between a closed position occluding the casing opening and an open position authorizing access to the casing. This is notably the case, but not limitatively, of some aerosol generation devices in which the casing is arranged for receiving a consumable comprising at least an aerosol-forming substance intended for generating an aerosol during a vaping session.

Generally, the body of the known portable devices comprises a dedicated button that is coupled to a mechanism, itself coupled to the closure element, and needing to be operated (or actuated) by the user each time he wants to use them and to open their casing (for instance to introduce or retrieve a consumable). So, the user needs to carry out one or more operations before accessing the casing, which appears to be a drawback for some users, for instance when they need to carry out several other operations for using their portable device (notably to prepare and start a vaping session).

Moreover, because of the small dimensions of the portable devices, the dedicated button allowing a user to control the mechanism can be easily operated by accident, for instance in a pocket or a bag, and therefore the mechanism and/or the closure element can be damaged or the object contained in the casing (for instance a consumable) may leave the latter which requires the user to insert it again into the casing (if it has not been damaged), or some dust particles or material residues can penetrate into the casing which may perturb operations (for instance aerosol generation) or may be dangerous for health (for instance when they are transformed by heating and mixed with the generated aerosol).

So, the present invention aims at improving the situation, and notably at allowing an automatic control of the closure element upon a specific detection of the user's hand on the portable device body.

### SUMMARY

The proposed invention provides an embodiment of a portable device comprising a body comprising a casing with an opening and a closure element moveable between a closed position occluding the casing opening and an open position authorizing access to the casing.

This portable device is characterized in that its body further comprises:
a first sensor set in a chosen area and arranged for detecting a user's hand holding the body in this chosen area, and
a mechanism arranged for causing the closure element to move to its open position when the user's hand has been detected by this first sensor.

Thanks to the invention, the closure element can be very simply and automatically actuated in response to the way the user is holding the portable device, specifically in response to the detection of the user's hand by the first sensor, without recourse to any dedicated operating button.

The first sensor is set, i.e., positioned, in a chosen area of the casing. The device body may comprise an external wall. The first sensor may be set, i.e., positioned, in a chosen area of the external wall.

The embodiment of portable device may comprise other features, considered separately or combined, and notably:
the first sensor may be chosen from a group comprising a capacitive sensor, a resistive film pressure sensor and a strain gauge;
the first sensor may be arranged for detecting the user's hand when the latter is exerting at least a predefined force in the chosen area during at least one predefined duration and a predefined number of times that is at least equal to one;
for instance, the predefined duration may be comprised between 500 ms and 2 s, the predefined force may be comprised between 2 N and 6 N, and the predefined number of times may be comprised between 1 and 3;
the body may comprise an external face comprising a plastic cover (possibly removable) in at least the chosen area. In this embodiment, the first sensor may be set between this external face and this plastic cover;
in an example of embodiment the closure element may comprise a first magnet, and the mechanism may comprise an electromagnetic coil arranged for generating a first magnetic field when the user's hand has been detected by the first sensor, in order to attract this first magnet to cause the closure element to move from a closed position to its open position;
in the last embodiment the mechanism may comprise a second magnet spaced apart from the first electromagnetic coil and arranged for generating a second magnetic field to attract the first magnet when the first electromagnetic coil no longer generates the first magnetic field, to cause the closure element to move from its open position to its closed position;
it may comprise an aerosol generation device, in which the casing is intended for receiving a consumable comprising at least an aerosol-forming substance. In this embodiment, it may comprise an aerosol generation unit comprising the casing and arranged for transforming the aerosol-forming substance into an aerosol that may be inhaled by the user, when it is supplied with electrical energy;
in the last embodiment, it may comprise a rechargeable battery storing electrical energy that is used by the aerosol generation unit for transforming the aerosol-forming substance into the aerosol and by the mechanism for causing the closure element to move to its open position;
also in the last embodiment, the body may comprise a second sensor arranged for detecting a consumable received in the casing, and the aerosol generation unit may be arranged for transforming the aerosol-forming substance into the aerosol when the second sensor has detected this consumable in the casing;
for instance, the second sensor may be chosen from a group comprising a photoresistor and a proximity sensor;
also for instance, the body may comprise a clear protective cover set in a hole communicating with the casing, between the second sensor and the casing for protecting the second sensor. This clear protective cover may be made of glass or plastic material (possibly with an antifouling coating), for instance;
also for instance, the second sensor may be arranged for detecting when the consumable is retrieved from the casing, and for causing a stop of the electrical energy supply to the aerosol generation unit after this detection;
also for instance the aerosol-forming substance may comprise a tobacco material or at least one polyol;
the portable device may constitute an electronic cigarette.

### BRIEF DESCRIPTION OF THE FIGURES

The invention and its advantages will be better understood upon reading the following detailed description, which is given solely by way of non-limiting examples and which is made with reference to the appended drawings, in which:

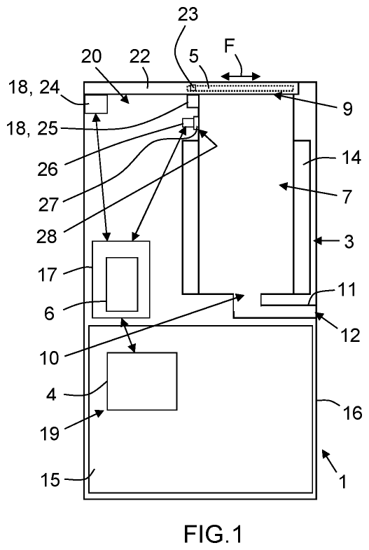

the FIG. 1 schematically and functionally illustrates, in a sectional view, an example of embodiment of a portable device according to the invention, with its closure element in its closed position before insertion of a consumable into its casing, and

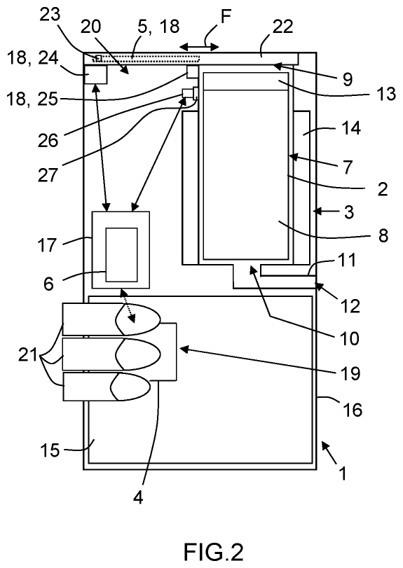

the FIG. 2 schematically and functionally illustrates, in a sectional view, the portable device of FIG. 1 after detection of a user's hand in a chosen area authorizing opening of its closure element and insertion of a consumable into its casing.

### DETAILED DESCRIPTION OF EMBODIMENTS

The invention aims at offering a portable device 1 that can be used by a user and having a closure element 5 controlling access to a casing 7 and whose setting in its open position depends on the position of a user's hand.

In the following description it will be considered that the portable device 1 is an aerosol generation device. But a portable device 1 according to the invention could be of another type, as soon as it comprises a closure element controlling access to a casing in which an object is intended to be introduced (or inserted) and retrieved.

Moreover, in the following description it will be considered that the aerosol generation device 1 is (or constitutes) an electronic cigarette (or e-cigarette or else personal vaporizer). But an aerosol generation device 1 according to the invention could be of another type, as soon as it allows to transform an aerosol-forming substance in solid form into an aerosol (possibly close to room temperature). More generally, a portable device 1 according to the invention concerns any aerosol generation device usually called T-vapor (or “heat-not-burn” (or HnB)) device comprising a heater for heating a solid substance.

Furthermore, in the following description it will be considered that the object intended to be introduced (or inserted) into the casing 7 is a consumable 2 comprising at least an aerosol-forming substance 8. For instance, this consumable 2 is a tobacco stick. So, the aerosol-forming substance comprises at least tobacco material (possibly shredded tobacco). But the invention is not limited to this type of consumable.

The term “aerosol-forming substance” is used to designate any solid material that is aerosolizable in air to form an aerosol. So, it may comprise one or more of nicotine, tobacco material, polyol, caffeine or other active components, or else flavoring.

Moreover, the term “aerosol” may include a suspension of substance as one or more of solid particles, liquid droplets and gas, and that such a suspension may be in a gas including air.

As illustrated in FIGS. 1 and 2 a portable device 1 (here an aerosol generation device), according to the invention, comprises at least a body 16 comprising a casing 7 with an opening 9, a closure element 5, a first sensor 4 and a mechanism 18.

The closure element 5 is moveable between a closed position, occluding the casing opening 9 and illustrated in FIG. 1, and an open position, authorizing access to the casing 7 and illustrated in FIG. 2.

The first sensor 4 is set in a chosen area 19 of the device body 16 and is arranged for detecting a user's hand 21 holding the device body 16 in this chosen area 19 (see FIG. 2).

For instance, the device body 16 comprises an external wall 20 having an external face on which this chosen area 19 is delimited for indicating a place where a part of a user's hand 21 must be located to be detected by the first sensor 4. The chosen area 19 is preferably defined where the user's hand 21 is usually partly positioned when the user uses the portable device 1 (for instance during a vaping session when it is an aerosol generation device).

In other words, this is only when a user's hand 21 is partly in contact with the chosen area 19 (here with at least one finger touching the latter (19)) that the first sensor 4 can detect it (preferably under certain condition(s) as explained below). The user's hand 21 in contact with the chosen area 19 (preferably under certain condition(s)) is considered as an intent to use the portable device 1.

The mechanism 18 is arranged for causing the closure element 5 to move to its open position when the user's hand 21 has been detected by the first sensor 4, as illustrated in FIG. 2.

So, the invention allows the closure element 5 to be actuated simply and automatically in response to the way the user is holding the portable device 1, without recourse to any dedicated operating button. The invention also offers an enhanced user experience, owing to the fact that it allows reducing the number of user's operations for using his portable device 1. Moreover, the portable device 1 being grip-dependent, the control of the mechanism 18 (allowing access to the casing 7) cannot be opened accidentally.

For instance, the first sensor 4 may be supplied with electrical energy (or power) by a power source 15 housed in the device body 16. But this is not mandatory. Indeed, the power source 15 could be housed in another body coupled to the body 16 by screwing by means of two corresponding threaded portions, or by clipping or else by means of magnets, for instance. Also for instance, the power source 15 may be a rechargeable battery. In this case the body 16 may comprise an electrical connector to which a charger cable may be connected during a charging session of the rechargeable battery 15. Such a charger cable may be coupled to an (AC) adapter or to a wall socket. The charger cable and/or the (AC) adapter may belong to the portable device 1.

Also for instance, the closure element 5 may be a slidable shutter that can be moved (arrow F) by the mechanism 18 between its closed and open positions. In the non-limiting example of FIGS. 1 and 2 the closure element 5 is a planar plate that is linearly moved and therefore translated. But the closure element 5 could have a curved shape and could follow a curved line when it is moved by the mechanism 18 between its closed and open positions. To ease the movement of the closure element 5 the device body 16 may comprise guiding members (or a rail) 22 in the vicinity of the casing opening 9, as illustrated in the non-limiting example of FIGS. 1 and 2.

Also for instance, the first sensor 4 may be a resistive film pressure sensor. In this case the first sensor 4 is arranged for detecting a pressure exerted by the user's hand 21 on the device body 16 in the chosen area 19. But in variants of embodiment the first sensor 4 could be a capacitive sensor (which detects capacitance variations caused by the presence of a finger on the device body 16 in the chosen area 19 or by a pressure exerted by the user's hand 21 on the device body 16 in the chosen area 19), or a strain gauge (which detects strain variations exerted by the user's hand 21 on the device body 16 in the chosen area 19), for instance.

In an example of embodiment, the first sensor 4 may be arranged for detecting the user's hand 21 when the latter (21) is exerting at least a predefined force in the chosen area during at least one predefined duration and a predefined number of times that is at least equal to one. In this case, the predefined duration may be comprised between 500 ms and 2 s. For instance, the predefined duration of the detected force (which may be a first condition to fulfill for detection) may be equal to 1 s. Also in this case, the predefined force may be comprised between 2 N and 6 N. For instance, the predefined force (which may be a second condition to fulfill for detection) may be equal to 4 N. Also in this case, the predefined number of times the force is detected may be comprised between one and three. For instance, the number of times (which may be a third condition to fulfill for detection) may be equal to two to avoid triggering of the closure element movement when the user inadvertently presses the chosen area 19 only one time without wanting to access to the casing 7.

Also for instance, the device body 16 may comprise an external face comprising a plastic cover in at least the chosen area 19. In this embodiment, the first sensor 4 is set (or sandwiched) between this external face and this plastic cover. This allows protection of the first sensor 4. This plastic cover is preferably removable when the first sensor 4 can be replaced.

As illustrated in the non-limiting example of FIGS. 1 and 2, the closure element 5 may comprise a first (permanent) magnet 23, and the mechanism 18 may comprise an electromagnetic coil 24 arranged for generating a first magnetic field when the user's hand 21 has been detected by the first sensor 4. This first magnetic field is intended for attracting the first magnet 23 to cause the closure element 5 to move from its closed position to its open position, as illustrated in FIG. 2. With such a mechanism 18, as long as the user's hand 21 is not detected in the chosen area 19 the electromagnetic coil 24 is not supplied with electrical energy, and therefore the closure element 5 remains in its closed position. Now, when the user's hand 21 is detected in the chosen area 19 the electromagnetic coil 24 is supplied with electrical energy originating from the power source 15, and therefore the closure element 5 reaches its open position.

For instance, the intensity of the first magnetic field may be comprised between 250 mT and 500 mT.

Also as illustrated in the non-limiting example of FIGS. 1 and 2, the mechanism 18 may comprise a second magnet 25 spaced apart from the first electromagnetic coil 24 and arranged for generating a second magnetic field. This second magnetic field is intended for attracting the first magnet 23 when the electromagnetic coil 24 no longer generates the first magnetic field, to cause the closure element 5 to move from its open position to its closed position. With such an embodiment, as soon as the electromagnetic coil 24 is no longer supplied with electrical energy, the closure element 5 moves automatically from its open position to its closed position, because the first magnet 23 is now attracted by the second magnetic field. This allows the casing 7 to be closed in a very simple manner, possibly without consuming any electrical energy when the second magnet 25 is permanent. But in a variant of embodiment the second magnet 25 could be an electromagnetic coil that is supplied with electrical energy when the casing 7 must be closed (i.e. when the electromagnetic coil 24 is no longer supplied with electrical energy).

With such an embodiment the mechanism 18 does not have mechanically complex moving parts, which increases notably its longevity and robustness.

It should be noticed that when the second magnet 25 is permanent the second magnetic field is also permanent. So, the intensity of the first magnetic field needs to be greater than the intensity of the second magnetic field, in order that the closure element 5 can be moved from its closed position to its open position. This condition relative to the intensity does not need to be implemented when the second magnet 25 is a second electromagnetic coil, because the controller 6 prevents the supply of electrical energy to the second electromagnetic coil 25 when it supplies electrical energy to the first electromagnetic coil 24 (and vice versa).

For instance, when the second magnetic field is permanent its intensity may be comprised between 250 mT and 500 mT. But, when the second magnetic field is not permanent its intensity may be equal to the intensity of the first magnetic field.

As illustrated non limitatively in FIGS. 1 and 2, when the portable device 1 is an aerosol generation device, its casing 7 is intended for receiving a consumable 2 (here a tobacco stick) comprising at least an aerosol-forming substance 8, and its body 16 comprises an aerosol generation unit 3. The latter (3) comprises the casing 7 and is arranged, when it is supplied with electrical energy originating from the power source 15, for transforming the aerosol-forming substance 8 mixed with air into an aerosol that may be inhaled by the user through successive draws (or “puffs” or inhalation phases) during a vaping session.

When the closure element 5 is in its open position (FIG. 2) the user can manually insert at least a part of a consumable 2 into the casing 7 that may be a heating chamber.

As illustrated in the non-limiting example of FIGS. 1 and 2, the casing 7 communicates with an air outlet 10 of an air flow channel 11 to be supplied with air originating from at least one air inlet 12 of this air flow channel 11. This allows mixing between the aerosol-forming substance 8 and the air.

Also as illustrated, the consumable 2 may comprise a filter 13, downstream of the aerosol-forming substance 8. In the non-limiting example of FIG. 2, the consumable 2 is fully inserted into the casing 7. But, as for a cigarette, the filter 13 could be at least partly and temporarily located in the mouth of the user and in this case it is used as a mouthpiece for inhaling the generated aerosol during each puff (or draw).

The aerosol-forming substance 8 is arranged for generating an aerosol when it is heated (without burning) and mixed with air. This heating is performed by a heater 14 supplied with electrical energy originating from the power source 15. This heater 14 may belong to the aerosol generation unit 3.

In the non-limiting example illustrated in FIGS. 1 and 2 the heater 14 surrounds the casing 7, and therefore a part of the consumable 2 (and more precisely its aerosol-forming substance 8) to heat the latter (8). For instance, the heater 14 may be a thin film heater wrapped around the outer surface of the casing 7 to heat its side walls and at least a part of its internal volume. But in a variant (not illustrated) the heater 14 could be a coil associated with a susceptor or a resistive coil heater. In the first alternative, the coil is arranged for generating an electromagnetic field when it is supplied with an electrical current, and the susceptor is arranged for transforming this electromagnetic field into heat. This susceptor may be a foil of the consumable 2 that surrounds, or is located inside, the aerosol-forming substance 8. In other variants of embodiment (not illustrated) the heater 14 could be located inside the consumable 2 or inside the casing 7.

For instance, the heater 14 may heat the aerosol-forming substance 8 to a temperature comprised between 150° C. and 350° C.

The electrical energy supplied to the heater 14 during a vaping session is controlled by a controller 6. This controller (or control unit) 6 may comprise at least a processor and a memory arranged for performing operations for controlling the aerosol generation unit 3, and notably its heater 14 during a vaping session and also the power source 15 during a possible charging session, and also the mechanism 18.

The electrical energy supplied to the electromagnetic coil 24 may also be controlled by the controller 6. In this case, each time the first sensor 4 detects the user's hand 21 in the chosen area 19 (possibly under the above mentioned condition(s)), it delivers a signal that is transmitted to the controller 6 and that is representative of the detection, and therefore the controller 6 allows the supply of electrical energy to the electromagnetic coil 24 to cause the closure element 5 to move to its open position.

For instance, the processor of the controller 6 may be a digital signal processor (or DSP), or an application specific integrated circuit (ASIC), or else a field programmable gate array (FPGA). More generally, the processor may comprise integrated (or printed) circuits, or several integrated (or printed) circuits connected therebetween through wired or wireless connections. The term “integrated (or printed) circuits” refers here to any type of device capable of carrying out at least one electric or electronic operation.

Also for instance, the memory of the controller 6 may be a random access memory (or RAM). But it may be any type of device arranged for storing program instructions for the processor.

Generally speaking, the functions of the controller (or control unit) 6 may be carried out through the operation of program logic, through dedicated logic, through the interaction of program control and dedicated logic, or even manually (by the user). These functions may be provided through the use of dedicated hardware as well as hardware capable of executing software in association with appropriate software.

As illustrated in the non-limiting example of FIGS. 1 and 2, the controller (or control unit) 6 (and notably its processor and memory) may be fixed onto a printed circuit board (or PCB) 17 (here housed in the body 16).

Also as illustrated in the non-limiting example of FIGS. 1 and 2, the device body 16 may comprise a second sensor 26 arranged for detecting a consumable 2 received in the casing 7. In this case the aerosol generation unit 3 may be arranged for transforming the aerosol-forming substance 8 into the aerosol when the second sensor 26 has detected the consumable 2 in the casing 7. In other words, when the second sensor 26 detects a consumable 2 in the casing 7, it delivers a specific first signal that is representative of this detection and that triggers the electrical energy supply of the heater 14, and therefore the generation of aerosol for inhalation. For instance, the delivered specific first signal may be transmitted to the controller 6, and therefore the controller 6 allows electrical energy to be supplied to the heater 14.

For instance, the second sensor 26 may be a photoresistor. But in a variant it could be a proximity sensor, for instance.

Also as illustrated in the non-limiting example of FIGS. 1 and 2, the device body 16 may comprise a clear protective cover 27 set in a hole 28 communicating with the casing 7, between the second sensor 26 and the casing 7 for protecting the second sensor 26. This prevents pollution or damage of the second sensor 26.

For instance, this clear protective cover 27 may be made of glass or plastic material, possibly with an antifouling coating.

Also for instance, the second sensor 26 may be arranged for detecting when the consumable 2 is retrieved from the casing 7 by the user, and for causing a stop of the electrical energy supply to the aerosol generation unit 3 after this detection.

In other words, when the second sensor 26 detects that there is no longer a consumable 2 in the casing 7, it delivers a specific second signal that is representative of this detection and that triggers the stop of the electrical energy supply to the heater 14, and therefore the end of the generation of aerosol. For instance, the delivered second specific signal may be transmitted to the controller 6, and therefore the controller 6 prevents the supply of electrical energy to the heater 14.

The controller (or control unit) 6 may also comprise, in addition to its processor and memory, an input interface, a mass memory (notably for storing intermediate data produced during its calculus and processing), and an output interface for delivering messages and instructions at least for controlling the aerosol generation unit 3 (and notably its heater 14), and the electronic component(s) (such as switch(es)) supplying the electrical power (stored in the power source 15) to the aerosol generation unit 3, the first sensor 4, the mechanism 18 and the possible second sensor 26.

It should be appreciated by those skilled in the art that some block diagrams of FIGS. 1 and 2 herein represent conceptual views of illustrative components (or constituents) or circuitry embodying the principles of the invention.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. A portable device comprising a body comprising a casing with an opening and a closure element moveable between a closed position occluding said casing opening and an open position authorizing access to the casing, wherein said body further comprises i) a first sensor set in a chosen area and arranged for detecting a user's hand holding said body in said chosen area, and ii) a mechanism arranged to move said closure element from said closed position to said open position when said user's hand has been detected by said first sensor.

2. The portable device according to claim 1, wherein said first sensor is at least one of a capacitive sensor, a resistive film pressure sensor, or a strain gauge.

3. The portable device according to claim 1, wherein said first sensor is arranged for detecting said user's hand when the user's hand is exerting at least a predefined force in said chosen area during at least one predefined duration and a predefined number of times that is at least equal to one.

4. The portable device according to claim 3, wherein said at least one predefined duration is in a range of 500 ms to 2 s, said predefined force is in a range of 2 N to 6 N, and said predefined number of times is in a range of 1 to 3.

5. The portable device according to claim 1, wherein said body further comprises an external face comprising a plastic cover in at least said chosen area, and wherein said first sensor is set between said external face and said plastic cover.

6. The portable device according to claim 1, wherein said closure element comprises a first magnet, and said mechanism comprises an electromagnetic coil arranged for generating a first magnetic field when said user's hand has been detected by said first sensor, in order to attract said first magnet to cause said closure element to move from said closed position to said open position.

7. The portable device according to claim 6, wherein said mechanism further comprises a second magnet spaced apart from said first electromagnetic coil and arranged for generating a second magnetic field to attract said first magnet when said first electromagnetic coil no longer generates said first magnetic field, to cause said closure element to move from said open position to said closed position.

8. The portable device according to claim 1, wherein said casing is configured to receive a consumable comprising at least an aerosol-forming substance, and wherein the device further comprises an aerosol generation unit comprising said casing and arranged for transforming said aerosol-forming substance into an aerosol configured to be inhaled by said user, when the aerosol generation unit is supplied with electrical energy.

9. The portable device according to claim 8, further comprising a rechargeable battery storing electrical energy that is used by said aerosol generation unit for transforming said aerosol-forming substance into said aerosol and by said mechanism for causing said closure element to move to said open position.

10. The portable device according to claim 8, wherein said body further comprises a second sensor arranged for detecting a consumable received in said casing, and wherein said aerosol generation unit is arranged for transforming said aerosol-forming substance into said aerosol when said second sensor has detected said consumable in said casing.

11. The portable device according to claim 10, wherein said second sensor is at least one of a photoresistor or a proximity sensor.

12. The portable device according to claim 10 or 11, wherein said body further comprises a clear protective cover set in a hole communicating with said casing, between said second sensor and said casing for protecting said second sensor.

13. The portable device according to claim 10, wherein said second sensor is arranged for detecting when said consumable is retrieved from said casing, and for causing a stop of electrical energy supply to said aerosol generation unit after this detection.

14. The portable device according to claim 8, further comprising a consumable comprising at least an aerosol-forming substance, wherein said aerosol-forming substance comprises a tobacco material or at least one polyol.

15. The portable device according to claim 8, wherein the portable device constitutes an electronic cigarette.

16. A portable device comprising a body comprising a casing with an opening and a closure element moveable between a closed position occluding said casing opening and an open position authorizing access to the casing, wherein said body further comprises i) a first sensor set in a chosen area and arranged for detecting a user's hand holding said body in said chosen area, and ii) an electromagnetic coil arranged for generating a first magnetic field and arranged to move said closure element from said closed position to said open position when said user's hand has been detected by said first sensor.
